(19) United States
(12) Patent Application Publication
(10) Pub. No.: US 2018/0012320 A1
(43) Pub. Date: Jan. 11, 2018

(54) METHOD AND APPARATUS FOR IMPROVED STUDENT MANAGEMENT

(71) Applicant: Emmanuel STONE, North Olmsted, OH (US)

(72) Inventor: Emmanuel STONE, North Olmsted, OH (US)

(21) Appl. No.: 15/659,847

(22) Filed: Jul. 26, 2017

Related U.S. Application Data
(63) Continuation-in-part of application No. 13/840,106, filed on Mar. 15, 2013, now abandoned.

(51) Int. Cl. G06Q 50/20; G09B 5/00; G06Q 10/10

(52) U.S. Cl. CPC G06Q 50/205; G06Q 10/10; G09B 5/00

(57) ABSTRACT

Improvements in administration are achieved by freeing personnel from the consequences of being at different locations and enabling a benefit from communications and related technologies. In one embodiment distance between an event, such as violation of behavior rules witnessed by staff, and the location of an administrator required to consent to imposition of disciplinary consequences is overcome. This is achieved by communicating the nature of the event and those involved to the administrator even though the administrator is absent from the scene of the event and allowing the administrator to consent to the imposition of disciplinary consequences without changing the administrator's location. In another embodiment, a student may request and receive a hall pass without interrupting a class or the teacher by communicating the request to a remote location enabled to agree or decline the student's request and communicate the response to the request back to the student. Data collected in the course of operation may be used to compute teacher effectiveness based on measured data.

### CROSS-REFERENCE TO RELATED APPLICATION

This application is a Continuation-in-part U.S. application Ser. No. 13/840,106, filed Mar. 15, 2013. All of the disclosures of which are incorporated herein by reference.

### BACKGROUND OF THE INVENTION

A fundamental problem all schools face is increasing student misbehavior. This may be due, in part, to growing populations and perhaps also changes in societal culture. Over time school districts have grown larger, some feel the need to lower expectations for student behavior yet are expected to maintain academic standards. The negative effect of these changes are exacerbated by the current student management system. Today's schools are grossly inefficient in delivering student discipline. To understand we must start with what happens in most schools when a student misbehaves to an extent that formal corrective action needs to be taken. While there may be minor differences between school districts, for the most part, the delivery of student discipline is virtually the same regardless of which district is involved. Because of the inefficient disciplinary delivery, at best, a student will not receive discipline until the following day. A significant consequence flows from the delay; the association in the student's mind between the misbehavior and the discipline is reduced. The reduced association between misbehavior and the consequent discipline also reduces the effectiveness of the discipline. The goal of discipline is to “teach” the student the negative consequences of ignoring rules of conduct. But reducing the association between the conduct and the discipline likewise reduces the effectiveness of the lesson.

The steps of a generic disciplinary process can be outlined as follows:

### School Discipline Process Steps

1. A student misbehaves.

2. A report on the behavior is prepared by a staff member observing the event. The report may also suggest specific student discipline.

3. The report is submitted to the administration.

4. An administrator (such as the Principal) reviews the report and initiates (or approves) student discipline.

5. Student receives the discipline.

When student misbehavior is witnessed by a teacher, the teacher files a report. The report is received by the principal. The student behavior report may be prioritized in order of greatest to least severe behavior relative to others. Once this is completed, there may be a hearing. When the hearing process is completed the student is then given a discipline. When a student misbehaves violently a fast response is necessary. Even if the misbehavior is not violent, a timely response is more effective in deterring future misbehavior than otherwise. The built in wait time inherent to typical disciplinary processes causes schools with larger populations, often in denser cities, to suffer from an inability to deliver discipline to students in a timely manner. This adversely affects the learning environment impacting the effectiveness of the academic setting.

Another facet of the problem of delivering timely discipline is the location of student files and discipline documentation. This material is typically in or adjacent the principal's office. This can be categorized as a Central Management Model. The Central Management Model physically receives, processes and stores most or all personal information, files and materials in one location (Office) forcing this location to directly process customer as well as written requests. This model is an ineffective means of moving our schools into the future. What's worse, this ineffective management model is seen in every type of school in the country; private, public, and charter—all of which claim to deliver appropriate educations yet continue to use the same inappropriate means of achieving that goal.

Even ignoring the delay inherent in transferring the need to act from teacher (initiating the disciplinary process) to the administrator (to authorize discipline), there is additional unnecessary delay simply because the teacher and administrator are typically in different locations; the teacher in a classroom and the administrator in an office. Even if the administrator is not in an office, it is likely the administrator is not in the teacher's classroom. While technology may be limited in speeding up procedures which require deliberate action of several parties, technology can overcome delays caused by remote locations of several parties.

The delivery of school discipline is representative of other functions where one party, at one location, proposes some action and another party, at a different location must approve or validate that action. The delivery of the function is impeded by the necessity for coordinated action by the two parties.

Another example of such other function is the request for and issuance of a hall pass. In this case a student makes a request of a teacher for permission to leave the classroom. In most schools, today the student must interrupt the activities of the teacher to make the request and receive a token indicating the request has been granted. This methodology can be improved.

A further problem in the school system is the lack of the ability to give a working measure of teacher effectiveness which is based on measurable data.

### SUMMARY OF THE INVENTION

In accordance with one aspect of the invention the foregoing problems are alleviated by providing a system including a communicating central device which includes a cpu, memory, a transmitter and receiver and communicating devices for personnel such as teachers and administrators (principal, etc.). The central device and communicating devices may communicate via a dedicated closed network. In that event, at least the central device will also have an interface with public communication networks such as the public switched telephone network and/or the internet or the like. Alternatively, the central and communicating devices may communicate via a public network.

A teacher communicating device (which is also available to other staff) includes a cpu, memory, a transmitter and receiver and an interface to allow the teacher to use the device as will be described. The administrator communicating device will be similar. The communicating devices have software which is personalized for the function of the device.

The teacher communicating device allows the teacher to select a discipline function via the interface. Once selected the device will allow the teacher to identify the student and infraction requiring discipline. In some embodiments, this selection will generate a proposed discipline. In other embodiments, the teacher may select a proposed discipline. In still other embodiments the proposed discipline is determined elsewhere. Having identified these parameters, the teacher device will allow the teacher to transmit a request for consent.

In some embodiments, the request for consent will be directed to the central device where it will be recorded. In case the proposed discipline is not a part of the request, logic in the central device will select a proposed discipline based on the infraction and the student's history. The request for consent is then forwarded to the administrator device. In other embodiments, the request will be directed to the administrator device. Receipt of the request at the administrator device will produce an image of the request on the display of the administrator device. The administrator may act on the request without further information by consenting to the request or declining to consent. Alternatively, the administrator may seek further information on the situation and only after having gathered the additional information deciding to consent to the request or declining to consent. The administrator's decision generates a message, at least to the central device, and perhaps to the requesting teacher device as well.

Receipt of the decision at the central device allows the discipline to be scheduled and whatever resources are needed to be allocated (i.e., supervision, location, etc.). The schedule information along with the name of the student is then incorporated into a message transmitted and to the student and/or the student's teacher and family.

Thus, in accordance with this aspect the invention provides a method for improving efficiency of administration of rules requiring consent of a supervisor before initiating an act proposed by an actor, the supervisor normally occupying a location which is different from a location normally occupied by the actor, where the method includes:

providing the actor and the supervisor with mobile communication devices,

maintaining the supervisor and actor communication devices so as to enable communications there between,

enabling transmission by the actor's communication device of identification of an action and a request for consent to that action, in response to an action of the actor which identifies the proposed action, and

enabling transmission by the supervisor's communication device, of consent to the action in response to an input by the supervisor manifesting consent.

In connection with another aspect, the invention provides an efficient implementation of the well known “hall pass” (permission to inhabit a portion of a school outside a classroom). In accordance with the invention this function can be automated to the extent that the teacher in the classroom need not be interrupted. In connection with this aspect of the invention a student accessible communicating device will be conveniently located, for example in many classrooms. The device will be capable of being operated by a student to identify the student and transmit a request for permission for the student to leave the classroom (inhabit a portion of the school outside the classroom). That request may be directed to the same central device already described (it may also be received by other devices, i.e., teacher(s) and administrator(s)), or it may be directed to a device dedicated only to the “hall pass” function which can be located in the same classroom or elsewhere). The receiving device will include the ability to respond with a message granting the request. That grant may be automatically created (for example based on additional information available from a database) and transmitted or it may be transmitted only after another person has manually consented to the request. In any event a grant of the student's request will be recorded. The student may be informed of the grant. The record of the grant can then be accessed from a communicating inquiry device in the event the student's right to inhabit a portion of the school outside the classroom is challenged.

In accordance with this aspect the invention provides a method of recording permission for a student to be outside a classroom during an instruction period, the method comprising:

providing a student accessible communication device enabling a student to request permission to inhabit a portion of a school outside a classroom,

transmitting from the student accessible communication device a student request for permission to inhabit a portion of a school outside a classroom,

providing a second communication device,

receiving the request at the second communication device,

transmitting from the second communication device an indication that the request is granted, and

in the event the request is granted, making a record of the granted request.

In accordance with an aspect of the invention a measure of teacher competence may be determined using the following metrics:

Student Engagement: This may be measured as a fraction of the student's time or effort which is actually devoted to the learning process. This fraction may be measured by quantifying the student's departure from full engagement due to one or more of the following: disciplinary incidents, absences from class, completing less than all homework assignments and completing less than all classwork assignments. This data may be collected by the apparatus already described.

Student Achievement: This may be measured by relatively conventional metrics such as objective scores on tests and/or subjective assessment of student achievement by a teacher.

It would be unfair to the teacher to assume that the student's failure to reach the level of ideal achievement is solely due to limited teacher effectiveness. The student's departure from ideal achievement may also be due to the student's departure from complete engagement in the learning process; i.e., the student is absent, fails to complete homework or class assignments or the student exhibits disciplinary incidents. By using the two parameters of student engagement and student achievement we can derive a measure of teacher competence.

In one formulation teacher effectiveness is computed as:

Student Engagement=(100%)−(%Discipline incidents+%Absences+%Classwork not completed+%Homework not completed)

Teacher Competence=(Student Engagement*Max Possible Achievement)−Max Percent Achievement−Student Achievement)*(−1)

### BRIEF DESCRIPTION OF THE DRAWINGS

The invention will now be described in detail in the following portions of the specification when taken in conjunction with the attached drawings in which:

FIG. 1 shows several communicating devices, some located in particular locations in a school, the communicating devices include a central device, a teacher device and a principal device;

FIG. 2 is a flowchart of the operations of one routine present in the central device;

FIG. 3 is a flowchart of the operations of one routine present in the teacher device;

FIG. 4 is a flowchart of the operations of one routine present in the administrator device;

FIG. 5 is a block diagram of a typical communicating device such as a teacher device or an administrator device;

FIG. 6 is a schematic diagram illustrating several devices which take part in implementing the hall pass function of the invention;

FIG. 7 is a flow diagram of the software in the central device 65 which implements the hall pass function.

FIG. 8 is an illustration of a portion of a data base in the memory of central device 50 useful in computing teacher competence.

FIG. 9 is a flow chart illustrating determination of teacher competence.

### DETAILED DESCRIPTION OF PREFERRED EMBODIMENTS

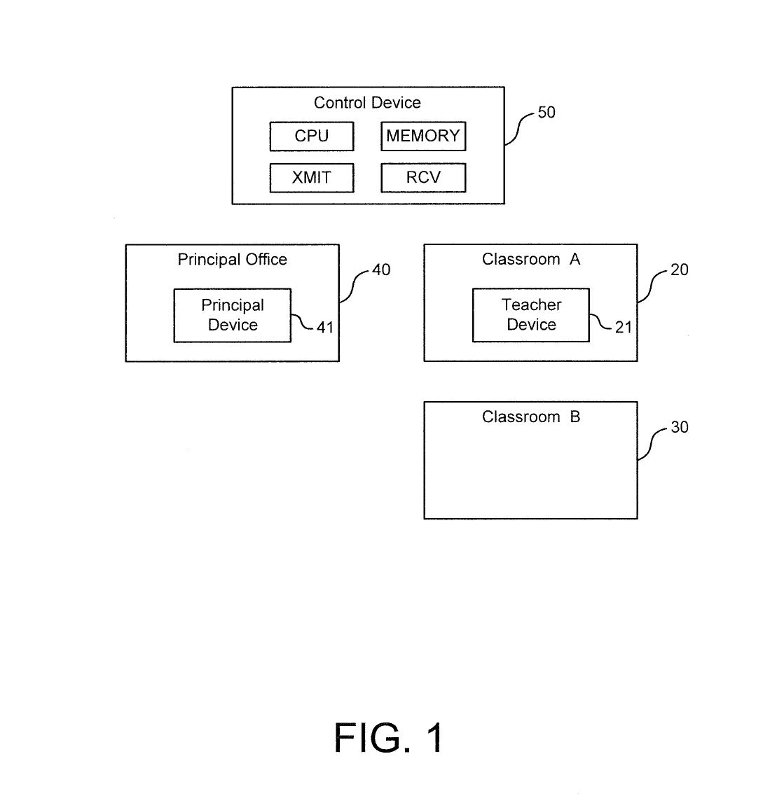

FIG. 1 diagrammatically shows three locations in a typical school, a principal's office 40 and classrooms A 20 and B 30. As shown in FIG. 1 a principal's communicating device 41 is located in the principal's office, a teacher's communicating device 21 is located in classroom A and a central communicating device 50 is located elsewhere, although it may be located at the typical school. Each of the communicating devices includes a cpu and memory as well as a data transmitter and receiver.

In one embodiment, the network on which the communicating devices transmit and receive is a closed network, i.e., the network is not open to the public. In this embodiment, the central device includes a transmitter and receiver which is accessible to a public network such as the public switched telephone network (PSTN) or to the Internet or the like. In another embodiment, all the communicating devices transmit and receive on a public network such as the public switched telephone network (PSTN) or to the Internet or the like. In this case these communicating devices may have security (such as the use of passwords or the like to limit access to the network) to limit access to the resources of these devices by strangers.

One function performed by the apparatus of FIG. 1 is to automate discipline related procedures, particularly making more efficient obtaining consent to proposed discipline from an administrator who may not have witnessed the act on which the discipline is predicated. In broad compass, in the example to be described a teacher in classroom A witnesses an act by a student in classroom A meriting some form of discipline. As will be described the invention allows the teacher to create and submit an appropriate disciplinary request without leaving classroom A, or to submit information from which an appropriate disciplinary request can be determined. Further the request will be accessible to the administrator whether the administrator is a dedicated office, another classroom or elsewhere so long as the administrator is accessible to whatever communication network is employed. The administrator will receive a request for consent message with information related to the infraction and the proposed discipline. At that or a later time the administrator may act on the request, either granting or denying the request by creating and transmitting a corresponding message. That message will be received and recorded at the central device and perhaps at other communicating devices (that of the teacher from classroom A). Recording of the consent will enable the discipline to be scheduled and messages regarding scheduling to be transmitted to the teacher and administrator (if necessary), the student and the student's family as well as to others involved in the scheduled discipline.

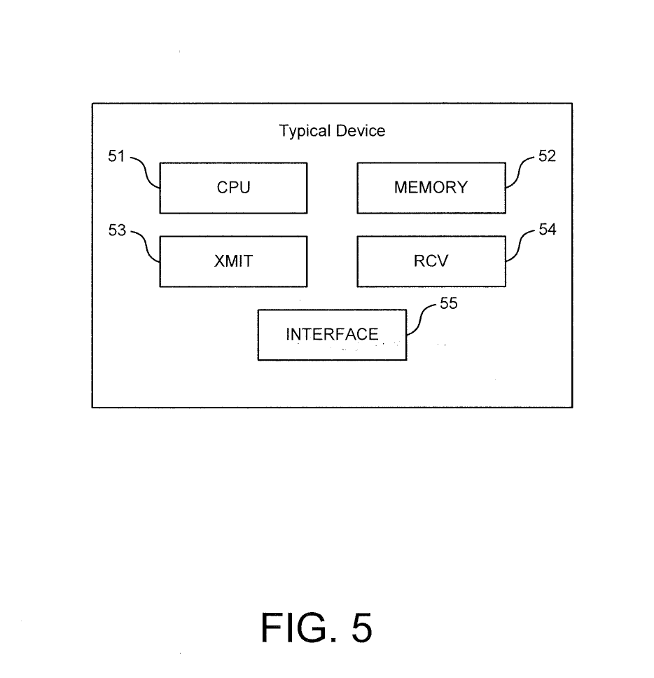

Reference is made to FIG. 5 to describe the components of the typical device (teacher communicating device and principal communicating device). As seen in FIG. 5 the device includes a cpu 51, memory 52, a transmitter 53, a receiver 54 and an interface 55. The operator interface may include a display and keyboard or keyboard equivalent. The memory 52 will store software routines appropriate to its function as well as data which may be necessary for performance of the desired functions. Both will be described in the following portions of this specification.

One important data component is a personnel database. One facet of the database will include student data such as name, homeroom, homeroom teacher, class schedule, family contact information (telephone number or e-mail address or both), disciplinary history, current scheduled discipline, teacher data including name, class schedule, contact information, etc., as well as a listing of disciplinary resources including locations, schedule for each location, identification of disciplinary supervisors and their schedule, etc. An example of the contents of a suitable data base is as follows:

Administrator(s)
name
link [address for the administrator's communicator]
schedule
signature

Teachers
name
link [address for the teacher's communicator]
signature
classes
   name
   classroom
      student complement
         schedule

Students
name
classes
discipline history
discipline scheduled
discipline pending
link to parents

maintenance
name
link
schedule
location

Classrooms
name
location
assets
   chairs
   textbooks
   communicator
      link

Disciplinary resources
room name
   location
   supervisor
      name
      link
      schedule

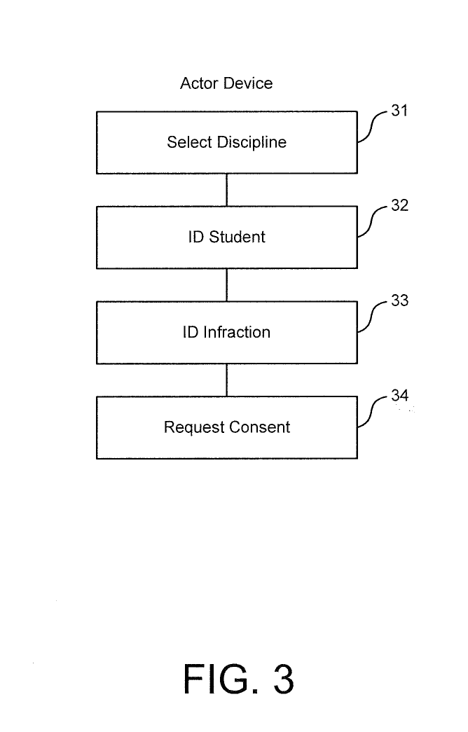

FIG. 3 illustrates the software routine found in a teacher communicating device dedicated to supporting the discipline function. The function is triggered by the user selecting a discipline function using the interface, function 31. The software allows the user to identify a student, function 32. There are many different procedures that can be used for this function. For example, the teacher communicating device may present the user will the ability to scroll through a text list of students. Alternatively, the user may be offered a sequence of student pictures to identify a particular student. In any event, after identifying a student the user is presented with the ability to select a particular infraction which is the basis for the discipline, function 33. One procedure for this selection is presenting a text list of infractions for selection. Another procedure is to allow the user to type in the name or other identifying name or phrase. In any event the device allows the user to identify student and infraction. Once the user confirms the information is correct another operation triggers transmission of a request message which identifies student and infraction. The request message is a request for consent to the discipline, function 34. Optionally the user may also select the appropriate discipline. Alternatively, the appropriate discipline will be selected by the system based on the infraction and the student's history as will now be described. In any event the request message will be received by the central communicating device 50.

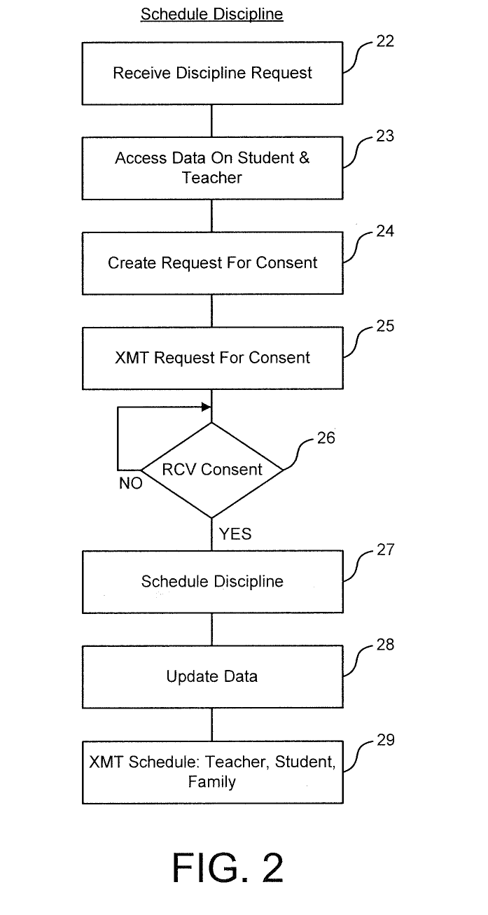

FIG. 2 shows the software routine at the central device used for the discipline function. As seen in FIG. 2 when the request message is received 22, function 23 executes to access data on the student identified in the consent message as well as the teacher. Based on this data the system may access a database to determine an appropriate discipline for the student. The appropriate discipline may be based both on the current infraction as well as the student's history of discipline and perhaps other factors. With this information, the system creates a request for consent message which identifies the student, infraction, teacher, selected discipline and transmits that message, 25. Thereafter the system monitors the received messages for a reply which includes a consent to the discipline which may be received from the administrator communicating device 41. When such a message is detected, 26, the system responds by storing some or all of the message, i.e., including the signature element. The system then performs function 27 to actually schedule the discipline. With the consent and selected discipline and student identification, access to a database of discipline resources will allow a tentative schedule for the discipline including time, day, location and perhaps supervisor. Once a tentative schedule is made the appropriate databases are updated at function 28. Thereafter messages are transmitted to the teacher, student and student family, function 29 identifying the tentative schedule.

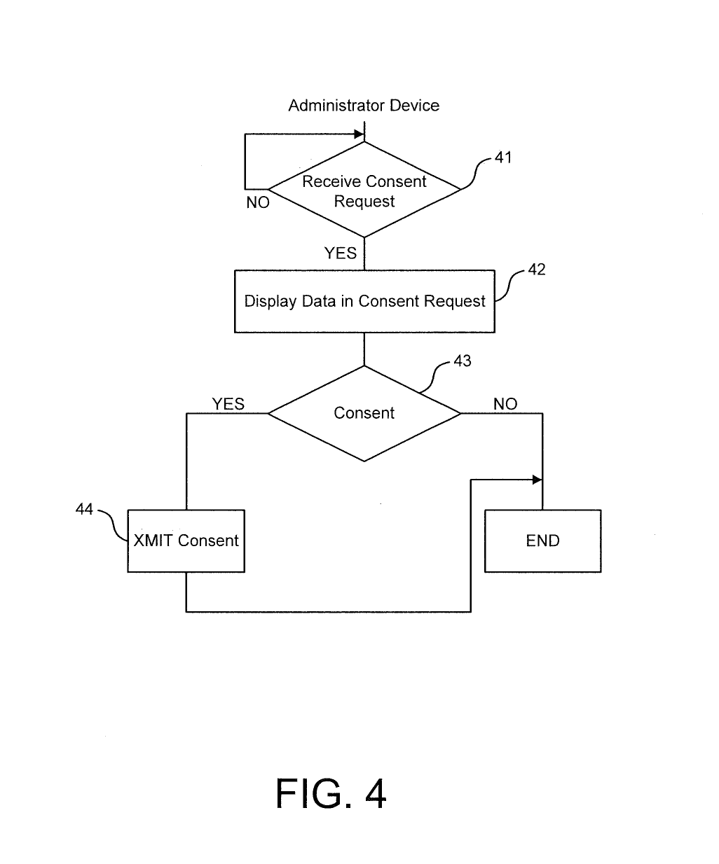

FIG. 4 shows the software routine in the administrator communicating device used for consenting to discipline. As shown in FIG. 4, the device monitors incoming messages for a request for discipline consent, function 41. When such a message is recognized, the data in the message (identifying student, infraction and particular discipline) is displayed for the user 42. At this point the user may either consent or decline to consent. User consent is monitored at function 43. The consent is manifested by the user operating the device interface. In the event, there is a consent, that selection triggers transmission of a consent to discipline message. Preferably the consent message includes a representation of the signature of the administrator which is derived from the database following the user's manifestation of consent. This message will identify the student, infraction and consent to discipline. That message will be received at the central device 50.

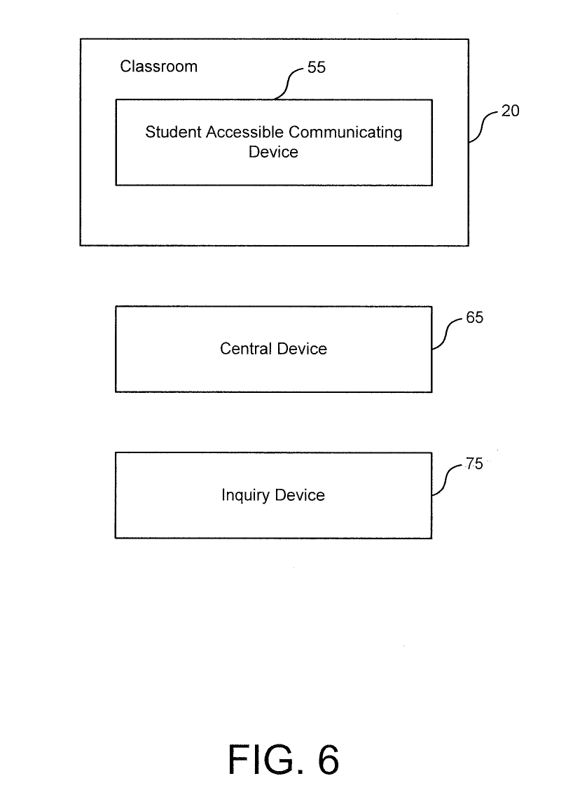

FIG. 6 is a schematic of a portion of a school and some of the equipment used in implementing another aspect of the invention. In particular FIG. 6 shows a classroom 20. Located in the classroom is a student accessible communicating device 55. Device 55 includes a cpu, memory, a human interface, a transmitter and a receiver. The transmitter and receiver of the device 55 allow messages to be sent to and received from other communicating devices, including a central device 65 and an inquiry device 75. The central device 65 may have components which are the same as those of the central device 50. The software stored in memory of the central device 65 however is specific to implementing the hall pass aspect of the invention as will be described.

The hall pass feature is initiated by a student operating a device 55. The student will operate the human interface to identify the student and initiate a hall pass request. The device will create a message including that information and perhaps the location of the device 55. The message will be transmitted to the central device 65, or to another device designed to process the hall pass request.

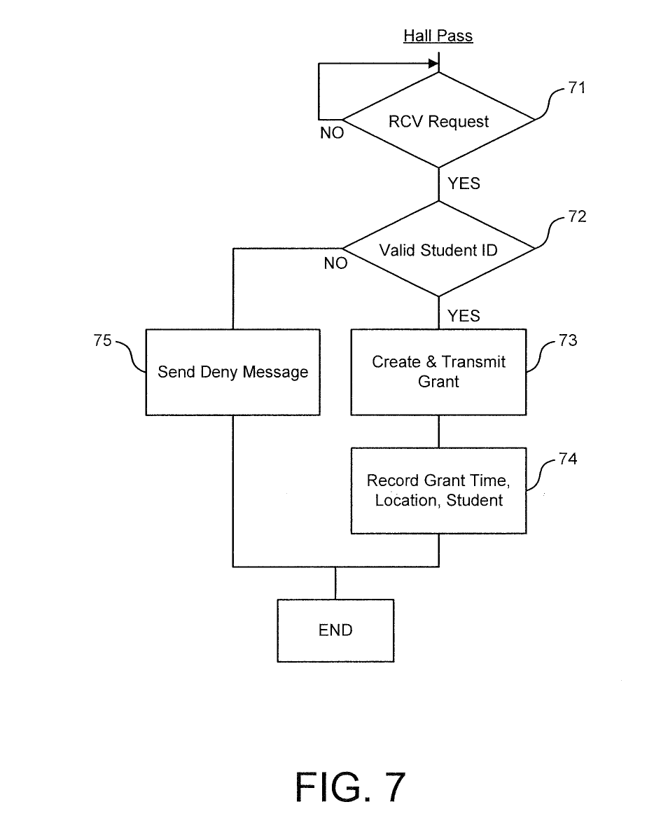

FIG. 7 shows operation of the hall pass function in the device 55. The process is initiated on detection of the receipt of a request at function 71. Thereafter the data contained in the request is verified, for example the student identification is verified at function 72. Other data may also be verified so the flow toward granting the request is only continued if the data is verified. In some embodiments, the granting function requires a manual procedure. In those cases, the flow from the YES branch of function 72 will wait receipt of the manual input before the flow continues on to function 73 or to function 75. Assuming the data is verified and no manual input is necessary then function 73 is performed to create and transmit a message granting the request. Thereafter a record is made, in a searchable data base reflecting the grant of the request. For example, the record might include the time of the grant, the location from which the message was received and identification of the student. On the other hand, if the data received with the request was not verified then the flow branches to function 75 which creates and transmits a deny request message.

The grant or deny messages transmitted by the device 55 will be received at the device 55. The receipt of the message will be reflected in the interface to inform the student whether or not the request has been granted. In the event that the request has been granted the student may immediately act on the grant by leaving the classroom in the knowledge that his leaving has been approved.

In the event the propriety of the student inhabiting a portion of the school outside the classroom is challenged resort may be had to an inquiry device 75. Inquiry devices 75 may be placed conveniently at various locations in the school or around the on school. The inquiry device will include similar components to the other devices, i.e., a cpu, memory, human interface, receiver and transmitter. Someone questioning the student will use the inquiry device to determine if the student's presence outside a classroom is authorized. This function is accomplished by inputting the student identification into the inquiry device 75. That action will prompt the device 75 to formulate and transmit a message including the student identification and location. That message will be received at the central device 65. The central device 65 will access the appropriate data, including the hall pass grant records. A message will be formulated and returned to the inquiry device 75 which reflects the data found in the hall pass grant records. Specifically, if there is a record of a current hall pass grant to the student in question, that fact or the details of the current hall pass grant to the student will be transmitted to the inquiry device 75. On the other hand, if there is no record of a current hall pass grant to the student the transmitted message will reflect that information. In this fashion the student can request, receive and act on a hall pass request without interrupting class work and without interrupting a teacher in the student's classroom.

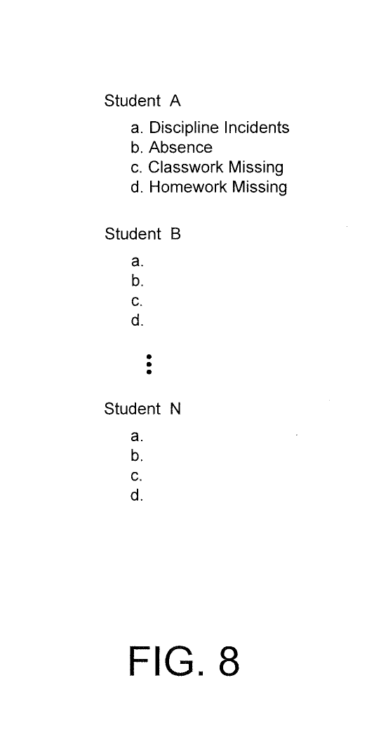

FIG. 8 shows data which is captured from the control device 50 which receives student data from various of the teacher devices 21. As represented in FIG. 8 the data captured for each student is identification of discipline incidents (for example specific incidents for each of the classes the student is assigned to for each day), absences (again absence incidence for each class the student is assigned to), classwork missing (again instances for each class the student is assigned to) and homework missing (again instances for each class the student is assigned to). This data is associated with a specific period, such as a day, week, month, semester, year, etc. Thus, the data may be used for computing parameters which represent the corresponding period.

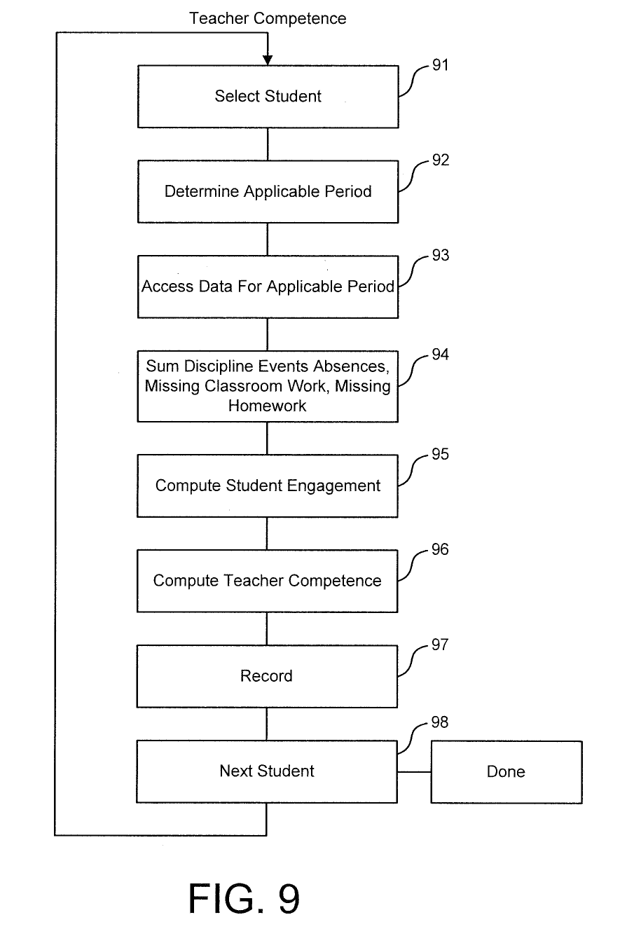

Given the availability of this data the flowchart illustrated in FIG. 9 can be executed to compute teacher competence using the relationships described above, namely:

Student Engagement=(100%)−(%Discipline incidents+%Absences+%Classwork not completed+%Homework not completed)

Teacher Competence=(Student Engagement*Max Possible Achievement)−Max Percent Achievement−Student Achievement)*(−1).

The parameters of Max Possible Achievement and Max Percent Achievement are constants, for example the standardized test which produces Max Possible Achievement has a value of 400. Max Percent Achievement is taken as 100%. Student Achievement is the student's score on the standard achievement test. Of course, other vehicles (such as observation and/or a combination of standardized testing and observation) can be used to determine Max Possible Achievement and the Student Achievement.

As an example, assume that student A has a period in which the data shows 9% discipline incidents, 10% absences, 8% classwork not completed and 4% homework not completed for a student engagement score of 69%. Student Achievement is determined by a standardized test which has a maximum score of 400 and Student A achieved a score of 273.

Given this data Teacher competence is determined (with respect to Student A) as:

Teacher effectiveness=(69%*400−100−273)*(−1)=97

Referring to FIG. 8 Teacher competence is calculated for a given student by executing functions 91-99. Function 91 selects a particular student. Function 92 determines an applicable period. Function 93 accesses the data corresponding to the selected period. This parameter may reflect a user input and is used to select the pertinent data. Function 95 sums the discipline events, absences, missing classwork and missing homework parameters. Based on this sum function 95 computes student engagement. Given student engagement and using the other parameters for the teacher effectiveness determination. Thereafter function computes teacher competence. The parameter may then be recorded (function 97). Thereafter the next student is selected (function 98) unless all students have been reviewed, in which case the loop ends at function 99.
It should be apparent that teacher competence can be determined based on data of plural students. In one embodiment, a teacher effectiveness is determined individually for each student and then the effectiveness parameters are averaged to obtain an overall teacher effectiveness parameter. In another embodiment, the different parameters for plural students are summed to obtain a sum of discipline incidents for the plural students, a sum of absences for the plural students, a sum for missing classwork and a sum for missing homework. Likewise, the student achievement is determined as the average over all the students. Then teacher competence is determined from the combined data.

While the foregoing specification describes specific characteristics of a preferred embodiment of the invention, those skilled in the art will understand that the scope of the invention is to be understood by the claims attached hereto and should not be limited by the specific characteristics which are described by way of example and not by way of limitation.

1. A method for improving efficiency of an interaction involving a supervisor and actor, the supervisor occupying a location which is different from a location occupied by the actor:
providing the actor and the supervisor with mobile communication devices,
maintaining the supervisor and actor mobile communication devices so as to enable communications there between,
selecting, by the actor a discipline function of said actor mobile communication device;
transmitting by the actor's mobile communication device, in response to an action of the actor, a message to said supervisor's mobile communication device, said message including identification of a proposed action and a request for consent to that action, said message generating an image on the supervisor's mobile communication device, and
transmitting, by the supervisor's mobile communication device to said actor's mobile communication device, a message including said consent, in response to an action of said supervisor.

2. The method of claim 1 which further includes:
providing a central device including a transmitter, a receiver, memory and a data processing unit,
said central device receiving and recording the messages.

3. The method of claim 2 wherein the actor is a classroom teacher, the supervisor is an administrator of a school in which the teacher is employed and the proposed action is a disciplinary action proposed by the teacher.

4. The method of claim 2 which further includes providing each of the mobile communication devices with protection against intrusion of unauthorized persons.

5. The method of claim 4 wherein the actor is a classroom teacher, the supervisor is an administrator of a school in which the teacher is employed and the proposed action is a disciplinary action proposed by the teacher.

6. The method of claim 5 wherein:
the memory stores identification of a student involved in said disciplinary action and related family members of said student as well as data defining at least one communication address for at least one family member of the student,
the message including identification of a proposed action includes identification of the student,
wherein the method further includes transmitting data representing the consent to the action, by the central device to at least one related family member of the student identified in the request for an action.

7. The method of claim 6 wherein the message including the request for an action includes a proposed date of the action.

8. The method of claim 7 wherein the central device receives communications initiated by said at least one related family member including information respecting acceptance of the proposed date of the action or alternatively proposing an alternative date.

9. The method of claim 8 wherein the central device may transmit an alternative date to the date received from the teacher's communication device.

10. The method of claim 8 wherein the central device transmits a reminder message to the at least one related family member a predetermined time in advance of the proposed date of the action.

11. A system employed by a supervisor and actor, the supervisor occupying a location which is different from a location occupied by the actor, said system including:
actor and supervisor mobile communication devices, each including a transmitter and a receiver,
said actor mobile communication device including a discipline function selection;
said actor mobile communication device including means for transmitting a message to said supervisor mobile communication device including identification of an action and a request for consent to the action, in response to the actor identifying the proposed action, and
said supervisor mobile communication device including means responsive to said message for generating an image on the supervisor mobile communication device, said supervisor mobile communications device further including means for transmitting a message to said actor communication device including said consent to the action in response to an input by the supervisor manifesting said consent.

12. The system of claim 11 which further includes:
a central device including a transmitter, a receiver, memory and a data processing unit,
said receiver responsive to messages transmitted by the actor and supervisor mobile communication devices and including means for storing in the memory the messages transmitted by the actor and supervisor mobile communication devices including identification of said action and said consent.

13. The system of claim 11 wherein the actor is a classroom teacher, the supervisor is an administrator of a school in which the teacher is employed and the action requiring consent is initiation of a disciplinary action proposed by the teacher.

14. The system of claim 11 in which both the actor and supervisor mobile communication devices includes means providing protection against intrusion by unauthorized persons.

15. The system of claim 12 wherein the actor is a classroom teacher, the supervisor is an administrator of a school in which the teacher is employed and the action requiring consent is initiation of a disciplinary action with respect to an identified student as proposed by the teacher.

16. The system of claim 15 wherein:
the central device stores identification of students and related family members as well as data defining at least one communication address for at least one related family member of the student,
wherein the central device further includes means for transmitting data representing the consent to the action to at least said one related family member of the student identified in the request for an action.

17. The system of claim 16 wherein the message including the request for consent includes a proposed date of the action.

18. The system of claim 17 wherein the central device includes means for receiving a message from said at least one related family member and including information respecting acceptance of the proposed date of the action or alternatively proposing an alternative date.

19. The system of claim 18 wherein the central device includes means to transmit message including an alternative date to the actor's mobile communication device.

20. The system of claim 19 wherein the central device includes means for transmitting a reminder message to the at least on related family member a predetermined time in advance of the proposed date of the action.

21. A system for measuring teacher competence based on achievement of a student, said system comprising;
a memory storing data related to the student including one or more of disciplinary incidents, absences from class, instances of incomplete homework assignment and instances of incomplete classroom work;
said memory further storing data related to achievements of the student based on one of a test score and observation, and
means for computing teacher effectiveness based on the foregoing data.

22. The system of claim 22 wherein measuring teacher competence is based on achievement of plural students.
